(19) United States
(12) Patent Application Publication
(10) Pub. No.: US 2006/0163888 A1
(43) Pub. Date: Jul. 27, 2006

(54) Double doorstop

(76) Inventor: Joan Bowser, Massillon, OH (US)

Correspondence Address: Bernt L. Moore;Buckingham, Doolittle & Burroughs, L.L.P., 4518 Fulton Drive NW, Canton, OH, 44735, US

(21) Appl. No.: 11/042,875

(22) Filed: Jan. 25, 2005

(51) Int. Cl. E05C 17/54

(52) U.S. Cl. 292/343

(57) ABSTRACT

The present invention relates to a door stop or door holder, having two weighted toy-like decorative bodies attached to one another via a flexible hinge enabling the device to be placed on the floor and arranged around a vertical door member to prevent inadvertent movement of the door.

This application claims the benefit of U.S. Provisional Application No. 60/539,057.

### BACKGROUND

1. Field of the Invention

This invention relates generally to a door stop or door holding apparatus used to prevent inadvertent movement of household doors. Such devices generally consist of a stationary member secured to the floor or wall and a member secured to the door, and which members interlock mechanically in order to deter movement of the door. Other types consist of nothing more than a weighted body or form that is filled with a heavy material and placed on one side of the door in order to impede movement of the door about its hinges. These simpler variations generally do not secure the door as firmly as their mechanical counterparts because the form is prone to slipping along the floor surface, however, the simpler versions do have benefits over the more complex stops and holders in that they do not become inoperative due to wear of the mechanically interlocking parts.

More particularly, the present invention pertains to a new and improved fanciful or toy-like door stop wherein the same is arranged to allow for placement on the floor and at the same time located around a door member in such a manner as to prohibit the door from swinging open or shut.

2. Description of the Prior Art

Door stops and holders of various types have been utilized in the prior art and exemplified by the U.S. Pat. Nos. 5,288,257; 5,044,681; 5,010,622; 4,657,293; and 4,998,941.

The present invention attempts to overcome the deficiencies of the prior art by directing the use to two simple weighted flexible form door stops that further provides for a connecting means between the same to allow the apparatus to be placed on the floor and located around a door member.

### SUMMARY

In view of the foregoing disadvantages inherent in the known types of door stop apparatus and door holding apparatus now present in the prior art, the present invention provides for a simplified door stop or door holder apparatus wherein two flexible weighted forms are connected by a flexible hinge that allows the door stop to be placed on the floor and located around the door member in such a manner as to allow the weighted cloth forms to be located on either side of the door member preventing inadvertent movement of the door member.

The invention resides not in any one of these features per se, but rather in the particular combination of all of them herein disclosed and claimed and it is distinguished from the prior art in this particular combination of its structures for the functions specified.

There has thus been outlined, rather broadly, the more important features of the invention in order that the detailed description thereof that follows may be better understood, and in order that the present contribution to the art may be better appreciated. There are, of course, additional features of the invention that will be described hereinafter. Those skilled in the art will appreciate the conception, upon which this disclosure is based, may readily be utilized as a basis for the designing of other structures, methods, and systems for carrying out the several purposes of the present invention.

Further, the purpose of the foregoing abstract is to enable the public generally to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new and improved doorstop which combines the advantages of the prior art door stop apparatus and none of the disadvantages.

It is another object of the present invention to provide a new and improved doorstop which may be easily and efficiently manufactured and marketed.

It is a further object of the present invention to provide anew and improved doorstop which is of a durable and reliable construction.

An even further object of the present invention is to provide a new and improved doorstop which is susceptible of a low cost manufacture with regard to both materials and labor, and which accordingly is then susceptible of low prices of sale to the consuming public, thereby making such door stops economically available to the buying public.

Still yet another object of the present invention is to provide a new and improved doorstop which provides in the apparatuses and methods of the prior art some of the advantages thereof, while simultaneously overcoming some of the disadvantages normally associated therewith.

For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

Other features and benefits of the invention will be more clearly understood with reference to the specification and the accompanying drawings, of which:

FIG. [1] is an isometric illustration of the structure of the present embodiment of the invention.

FIG. [2] is an isometric illustration indicating the placement of the present embodiment of the invention relative to a door member.

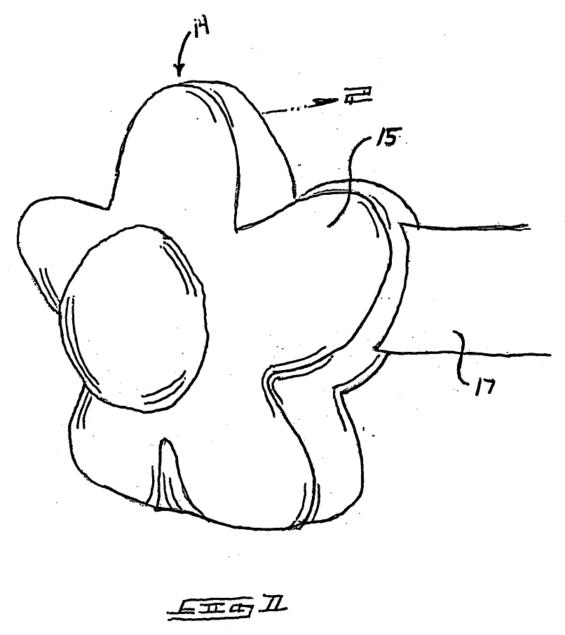

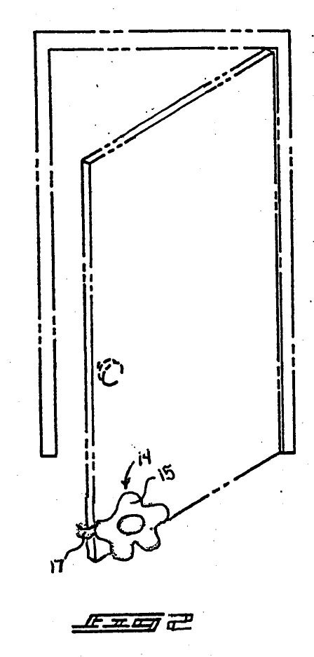

FIG. [3] is an orthographic view taken along the lines 2-2 of FIG. 1 in the direction indicated by the arrows.

### DESCRIPTION

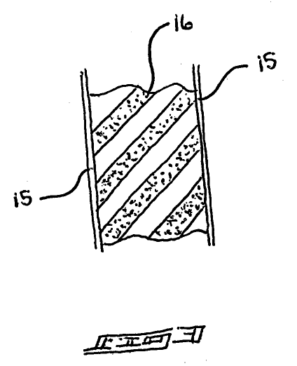

With reference now to the drawings, and in particular to FIGS. 1 and 2, a doorstop and holder according to an exemplary embodiment of the present invention for use in conjunction with a corresponding door member, for example: a set of two figure bodies [14], formed of an outer flexible material [15] enclosing a body cavity [16] that in turn is filled with poly-fill beads coextensively directed within the body cavity [16]; a hinge body [17], formed of a flexible material and having two opposing ends fixedly attached to the two separate figure bodies [14].

As to the manner of usage and operation of the instant invention, the same should be apparent from the above disclosure, and accordingly no further discussion relative to the manner of usage and operation of the instant invention shall be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. Apparatus for holding or stopping a household door, the apparatus comprising:
(a) two figure bodies, formed from an outer flexible material enclosing a body cavity, such cavity containing a weighted material;
(b) a flexible hinge body, having two opposing ends, each of said ends fixedly attached to separate figure bodies, enabling the figure bodies to be placed on a floor and arranged around a vertical door member.

2. Apparatus of claim 1, wherein the figure bodies are comprised of fabric.

3. Apparatus of claim 1, wherein the hinge body is comprised of fabric.

4. Apparatus of claim 1, wherein the body cavity contains poly-fill beads.

5. Apparatus for holding or stopping a household door, the apparatus comprising;
(a) two figure bodies, made of fabric enclosing a body cavity, such cavity containing Polly-fill beads;
(b) a flexible hinge body made of fabric, having two ends, said ends sewn to separate body figures, enabling the figure bodies to be placed on a floor and arranged around a vertical door member.
